(19) United States
(12) Patent Application Publication
(10) Pub. No.: US 2026/0205732 A1
(43) Pub. Date: Jul. 16, 2026

(54) SYSTEMS AND METHODS FOR AUDIO POSITION ADJUSTMENT

(71) Applicant: Harman International Industries, Incorporated, Stamford, CT (US)

(72) Inventors: Chris LUDWIG, Bloomfield Hills, MI (US); Riley WINTON, Opelika, AL (US); Chris TRESTAIN, Stamford, CT (US)

(73) Assignee: Harman International Industries, Incorporated, Stamford, CT (US)

(21) Appl. No.: 19/561,067

(22) Filed: Mar. 9, 2026

Related U.S. Application Data
(63) Continuation of application No. PCT/US2024/046824, filed on Sep. 14, 2024.
(60) Provisional application No. 63/583,087, filed on Sep. 15, 2023.

(51) Int. Cl. H04R 1/32; B60K 35/10; B60K 35/80; H04R 29/00

(52) U.S. Cl. CPC H04R 1/323; B60K 35/10; B60K 35/80; H04R 29/001; B60K 2360/122; B60K 2360/741; H04R 2499/13

(57) ABSTRACT

A method includes the identification of a landmark associated with an operator of a vehicle, the determination of a location associated with the operator based on the identification of the landmark, and the automatic adjustment of a position of one or more speakers disposed within a headrest of the vehicle in response to the determination of the location.

### CROSS-REFERENCE TO RELATED APPLICATIONS

This application is a continuation of International Application No. PCT/US2024/046824, filed on September 14, 2024, which claims priority to and the benefit of U.S. provisional application number 63/583,087 filed on September 15, 2023. The disclosure of the above application is incorporated herein by reference in its entirety.

### FIELD

The present disclosure relates to an adjustment of an audio position, and more particularly to systems and methods for automatically adjusting one or more speakers relative to a location of a physical feature of a human.

### BACKGROUND

The statements in this section merely provide background information related to the present disclosure and may not constitute prior art.

While vehicle designs begin to integrate speakers within headrests in an attempt to elevate a user experience, inherent properties of the speakers may still inhibit such an elevation of the user experience. For example, the speakers often produce sound in a directional manner and therefore are unable to accommodate different heights of the user and/or different head widths of the user. As another example, the speakers may direct sounds in ways that reduce the user experience or sound quality. Constraints on the installation space may further reduce user experience or sound quality.

The present disclosure addresses these and other issues related to viewing external surroundings, particularly of from within a vehicle.

### SUMMARY

This section provides a general summary of the disclosure and is not a comprehensive disclosure of its full scope or all of its features.

The present disclosure provides a method comprising: identifying a landmark associated with an operator of a vehicle; determining a location associated with the operator based on the identification of the landmark; and automatically adjusting a position of one or more speakers disposed within a headrest of the vehicle in response to the determination of the location; wherein the location is based on a physical feature of the operator, and wherein the physical feature includes at least one ear of the operator, a nose of the operator, a mouth of the operator, a width of a head of the operator relative to a face of the operator, or a combination thereof; wherein the determination of the location comprises: analyzing, via a vehicle-side algorithm, one or more image-related signals based on the landmark, wherein the landmark is an eyebox associated with the operator of the vehicle; wherein the automatic adjustment of the position of the one or more speakers changes an angular position of the one or more speakers; wherein the automatic adjustment of the position of the one or more speakers changes a height of the one or more speakers; further comprising: adjusting content output by the one or more speakers based on the location, wherein the adjustment of the content changes an equalization of the content, a delay compensation of the content, a gain compensation of the content, a sound level of the content, or a combination thereof; further comprising: adjusting content output by another speaker based on the location, wherein the adjustment of the content changes an equalization of the content, a delay compensation of the content, a gain compensation of the content, a sound level of the content, or a combination thereof.

The present disclosure provides a system comprising: one or more cameras associated with a vehicle, wherein the one or more cameras is configured to identify a landmark associated with an operator of the vehicle; and a controller associated with the vehicle, wherein the controller is configured to: determine a location associated with the operator based on the identification of the landmark, and cause an adjustment of a position of one or more speakers disposed within a headrest of the vehicle in response to the determination of the location, wherein the headrest is configured to automatically adjust the position of the one or more speakers; wherein the location is based on a physical feature of the operator, and wherein the physical feature includes at least one ear of the operator, a nose of the operator, a mouth of the operator, a width of a head of the operator relative to a face of the operator, or a combination thereof; wherein the controller configured to determine the location is further configured to: analyze, via a vehicle-side algorithm, one or more image-related signals based on the landmark, wherein the landmark is an eyebox associated with the operator of the vehicle; wherein the automatic adjustment of the position of the one or more speakers changes an angular position of the one or more speakers; wherein the automatic adjustment of the position of the one or more speakers changes a height of the one or more speakers; wherein the controller is further configured to: adjust content output by the one or more speakers based on the location, wherein the adjustment of the content changes an equalization of the content, a delay compensation of the content, a gain compensation of the content, a sound level of the content, or a combination thereof; and wherein the controller is further configured to: adjust content output by another speaker based on the location, wherein the adjustment of the content changes an equalization of the content, a delay compensation of the content, a gain compensation of the content, a sound level of the content, or a combination thereof.

The present disclosure provides one or more non-transitory computer-readable media storing processor-executable instructions that, when executed by at least one processor, cause the at least one processor to: identify a landmark associated with an operator of a vehicle; determine a location associated with the operator based on the identification of the landmark; and automatically adjust a position of one or more speakers disposed within a headrest of the vehicle in response to the determination of the location; wherein the location is based on a physical feature of the operator, and wherein the physical feature includes at least one ear of the operator, a nose of the operator, a mouth of the operator, a width of a head of the operator relative to a face of the operator, or a combination thereof; wherein the at least one processor is further caused to: analyze, via a vehicle-side algorithm, one or more image-related signals based on the landmark, wherein the landmark is an eyebox associated with the operator of the vehicle; wherein the automatic adjustment of the position of the one or more speakers changes an angular position of the one or more speakers; wherein the automatic adjustment of the position of the one or more speakers changes a height of the one or more speakers; wherein the at least one processor is further caused to: adjust content output by the one or more speakers based on the location, wherein the adjustment of the content changes an equalization of the content, a delay compensation of the content, a gain compensation of the content, a sound level of the content, or a combination thereof; or adjust content output by another speaker based on the location, wherein the adjustment of the content changes an equalization of the content, a delay compensation of the content, a gain compensation of the content, a sound level of the content, or a combination thereof.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 illustrates an example representation of a driving environment in accordance with one or more embodiments of the present disclosure;

FIGS. 2A and 2B illustrate an example of an adjustable headrest in accordance with one or more embodiments of the present disclosure;

FIG. 3 illustrates a driving environment showing movement of a vehicle driver in accordance with one or more embodiments of the present disclosure;

FIGS. 4-7 illustrate example methods for audio position adjustment relative to a headrest associated with a vehicle in accordance with one or more embodiments of the present disclosure; and

FIG. 8 is a block diagram illustrating an example computer system in accordance with one or more embodiments of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

One or more embodiments of the present disclosure provide systems and methods for automatically adjusting one or more speakers (e.g., disposed within a headrest of a vehicle) relative to a location of a physical feature of a human (e.g., operator of the vehicle). For example, standard camera technology (or other imaging technology) is utilized to deduce the human’s head position to automatically adjust a position of the headrest (and associated speakers) to compensate for varying sizes and positioning of the human’s head. As another example, the compensation results in the reduction of the operator’s burden (e.g., no manual adjustment of the headrest is required) and the overall improvement of an audio experience.

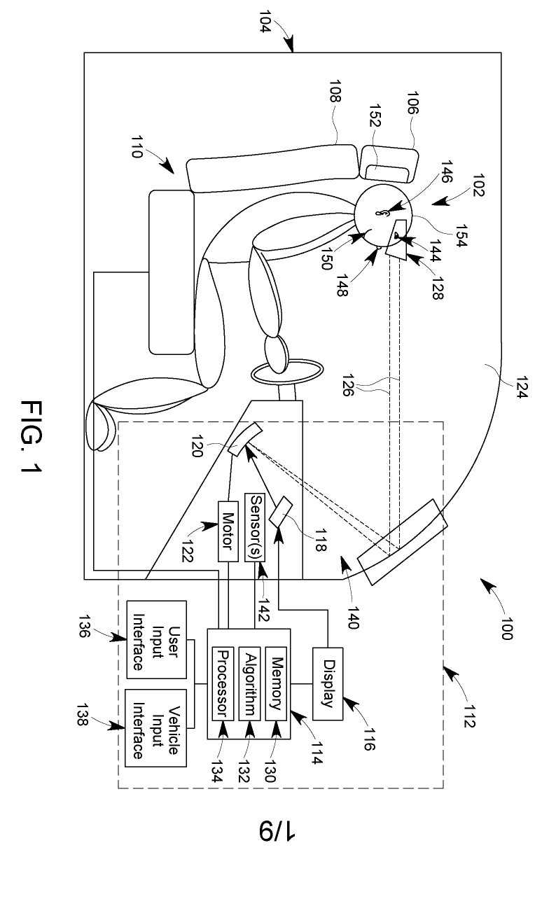

FIG. 1 generally illustrates a driving environment 100, wherein a driver 102 is operating a vehicle 104. In one or more embodiments, the vehicle 104 includes an adjustable headrest 106 attached to a backrest 108 of a driver seat 110. The vehicle 104 also includes a heads-up display (HUD) arrangement 112. It is understood that the vehicle 104 can include any number of components related to the vehicle 104 not depicted in FIG. 1. It is also understood that the components (e.g., the adjustable headrest 106, the backrest 108, the driver seat 110, and the HUD arrangement 112) depicted in FIG. 1 are not required for operation of the vehicle 104.

The HUD control arrangement 112 generally includes a video display controller 114, a display 116, a first mirror 118, a second mirror 120, and a motor 122. In some examples, the HUD control arrangement 112 is implemented within the vehicle 104 to adjust a display level of HUD information projected onto a windshield 124. It should be understood, however, that the HUD control arrangement 112 can be implemented within any general structure wherein HUD information may be displayed, such as a helmet or glasses and is not limited to the examples described herein.

In one or more examples, the first mirror 118 is a fold mirror, which can be planar or aspherical and reflects received light toward the second mirror 120. As another example, the second mirror 120 is a tiltable mirror, which can be aspherical and direct light toward the windshield 124. The direction of the light directed from the second mirror 120 is controlled to be within an optical path 126 that originates from an eyebox 128 of a user and represents at least a portion of a viewable range of the driver 102 in various examples. It is understood that the optical path 126 may vary based on the height of the eyebox 128 of the user. It is further understood that the height of the eyebox 128 may be based on the height of the driver 102.

In one or more embodiments, the video display controller 114 includes a memory 130, an algorithm 132, and a processor 134, wherein the processor 134 is configured to execute instructions stored in the memory 130 to control the motor 122 and/or the output of the display 116. It is understood that the display 116 outputs an image or other data and/or a light to be reflected against the first mirror 118. The video display controller 114 may control the display 116 to project particular images and/or light based on the instructions stored in the memory 130 and/or based on other inputs from the driver 102. For example, a user input interface 136 and a vehicle input interface 138 may be used to provide instructions to the video display controller 114 to control the display 116 based on user input (e.g., input from the driver 102) and vehicle data/status, respectively. For example, user input to change a type of information displayed (e.g., to select between instrument data such as speed/RPM/etc. and navigation data such as turn directions), to select options when a graphical user interface is displayed, and/or to otherwise indicate preferences of the driver 102 are provided to the video display controller 114 and processed to alter a content, height, and/or format of the displayed data. As an example, the content may be data (e.g., music files video files, recorded sound waves, etc.). It is understood that the user input interface 136, in some examples, receives user input from any suitable user input device, including but not limited to a touch screen, vehicle-mounted actuators (e.g., buttons, switches, knobs, dials, etc.), a microphone (e.g., for voice commands), an external device (e.g., a mobile device of a vehicle occupant), and/or other user input devices.

The vehicle input interface 138 receives data from vehicle sensors (not shown) and/or systems indicating a vehicle status and/or other vehicle data, which may be sent to the video display controller 114 to adjust content and/or format of the displayed data. For example, a current speed may be supplied (e.g., via a controller-area network, CAN, bus of the vehicle 104) to the vehicle input interface 138 and sent to the video display controller 114 to update the display of a current speed of the vehicle 104. The vehicle input interface 138 may also receive input from a navigation module (not shown) of the vehicle 104 and/or other information sources within the vehicle 104.

In one or more embodiments, the video display controller 114 is also configured to activate the second mirror 120 via the motor 122. For example, the video display controller 114 sends instructions to the motor 122 to drive a tilt of the second mirror 120 to a specific angle or degree. For example, it is understood that the second mirror 120 is tilted to a degree of +/-1. However, it is understood that the second mirror 120 may be tilted to any degree. It is understood that the tilt of the second mirror 120 is based on an input of the driver 102 via the user input interface 136. In some examples, the motor 122 is a brushless DC electric motor. The motor 122 drives the tilt of the second mirror 120 to multiple positions so that the direction of light may change so that a display region 140 may be displayed to the driver 102 at different levels or heights. As another example, the motor 122 drives the tilt of the second mirror 120 based on the height of the eyebox 128 of the driver 102. As a further example, the motor 122 drives the tilt of the second mirror 120 based on preferences of the driver 102 provided via the user input interface 136.

The vehicle 104 also includes one or more sensors 142 (e.g., one or more cameras) disposed within the HUD arrangement 112. In one or more embodiments, the one or more sensors 142 are configured to detect a position of the eyebox 128 of the driver 102 so that an eye(s) 144 position of the driver 102 is identified. It is understood that the one or more sensors 142 are also configured to identify any other features of the driver 102 (e.g., eye(s) 144, ear(s) 146, nose 148, mouth 150). As an example, the processor 134 is also configured to process one or more image-related signals (e.g., raw data or any other type of data) received at the controller 114, from the one or more sensors 142. In another example, the algorithm 132 is configured to analyze the one or more image-related signals to determine a location of the ear(s) 146 of the driver 102. As yet another example, the algorithm 132 utilizes the position of the eye(s) 144 as a landmark to determine the location of the ear(s) 146. As a further example, the algorithm 132 can determine the location of the ear(s) 146 by implementing a machine learning or artificial intelligence-related process or method. As an additional example, the algorithm 132 can also use a neural network to segment pixels of an image of the identified feature of the driver 102 and determine the location of the identified feature within the image by using a bounding box or any other means of image-analysis. It is understood that other suitable methods may be used.

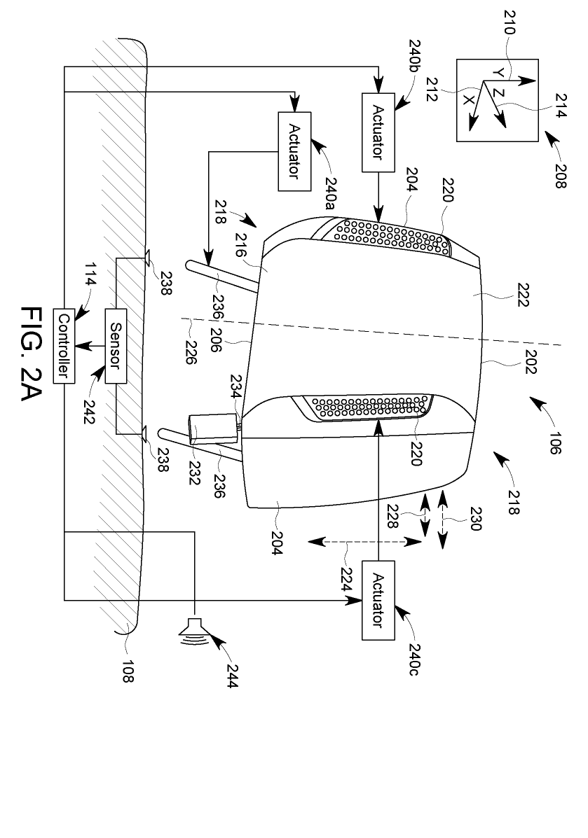

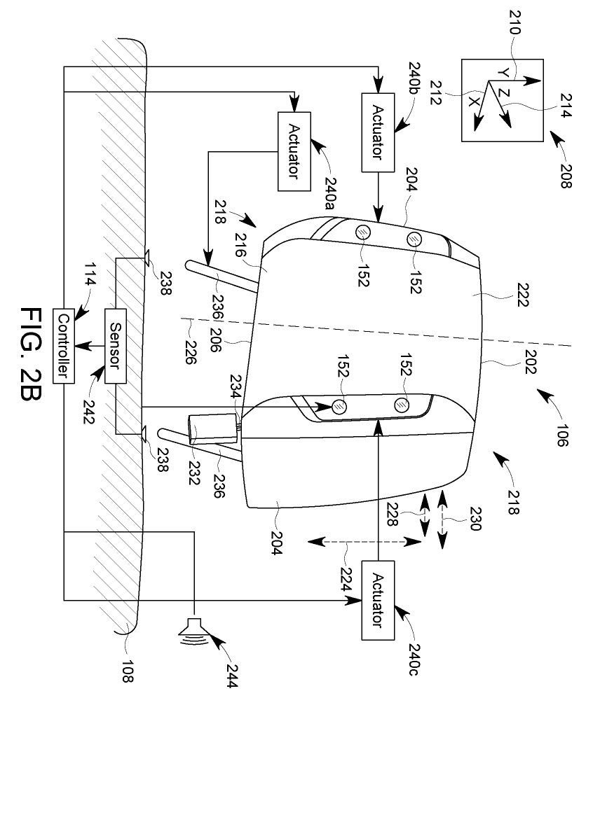

The driver seat 110 is configured to be communicatively connected (e.g., via a wired or wireless means) to the controller 114. The adjustable headrest 106 is configured to be communicatively connected to the backrest 108 of the driver seat 110 via a plug (e.g., the plug 232 shown in FIGS. 2A and 2B). The adjustable headrest 106 includes one or more transducers 152 (e.g., one or more speakers) and is understood to be a headrest that may be used within the vehicle 104, a movie theatre, and/or in any other environment. In response to the determination of the location of the ear(s) 146, the controller 114 can cause a first actuator of a plurality of actuators (e.g., the first actuator 240a of the plurality of actuators 240a-240c shown in FIGS. 2A and 2B) to automatically adjust the adjustable headrest 106. For example, the adjustable headrest 106 is automatically adjusted to position the one or more transducers 152 at an optimal location relative to the location of the ear(s) 146. It is understood, however, that the adjustable headrest 106 can be automatically adjusted to position the one or more transducers 152 at an optimal location relative to the location of any of the identified features. For example, the identified features can include a width of a head 154 of the driver 102 and the location may be the outer perimeter of the face of the driver 102 that is a basis for the adjustment of the one or more transducers 152.

As another example, the optimal location can be a predefined offset threshold from which the ear(s) 146 should be located in relation to the position of the one or more transducers 152 for the provision of an optimal experience for the driver 102. As yet another example, the adjustable headrest 106 is adjusted along a vertical plane (e.g., up or down). As a further example, the one or more transducers 152 are adjusted along a horizontal plane (e.g., toward a head 154 of the driver 102 or away from the head 154 of the driver 102). As an additional example, a narrower head 154 of the driver 102 may receive a better user experience if the one or more transducers 152 are oriented inward from the adjustable headrest 106 and toward the ear(s) 146 of the driver 102 by adjusting an angle of the one or more transducers 152. As another example, a wider head 154 of the driver 102 may receive a better user experience if the one or more transducers 152 are oriented outward from the adjustable headrest 106 and away from the ear(s) 146 of the driver 102 such that the same distance is established between the one or more transducers 152 and the ear(s) 146 of the driver 102, regardless of a size of the head 154. However, it is understood that, in an instance wherein the predefined offset threshold is satisfied, no adjustment to the adjustable headrest 106 and/or the one or more transducers 152 may occur.

While FIG. 1 depicts the driver 102 as operating the vehicle 104, it is understood that any of the related disclosure herein can be applicable to a passenger of the vehicle 104 located in any seat of the vehicle 104, such as a front-passenger seat or a rear-passenger seat, for example.

Turning now to FIG. 2A, the adjustable headrest 106 may have a generally trapezoidal outline with a top end 202, a set of sides 204 (collectively referred to as “the sides 204”), and a bottom end 206. It is understood, however, that the adjustable headrest 106 can be manufactured in any shape and is not limited to a trapezoidal-related shape. A set of reference axes 208 is provided for relational positioning of aspects associated with the adjustable headrest 106, indicating a vertical "y" direction 210, a horizontal "x" direction 212, and a lateral "z" direction 214. The sides 204 are slanted with respect to the vertical direction 210 so the distance between the tops of the sides 204 is shorter than the distance between the bottoms of the sides 204. The regions at which the top end 202 mates with the tops of the sides 204 and the bottom end 206 mates with bottoms of the sides 204 may be curved. The top end 202 and the sides 204 may be slightly curved along the respective horizontal and vertical directions and the bottom end 206 may be substantially straight along the respective horizontal direction. The adjustable headrest 106 may have a thickness, measured along the lateral direction 214, that may be greatest at the bottom end 206 and that decreases non-linearly in thickness along the vertical direction 210 towards the top end 202.

A central region 216 of the adjustable headrest 106 acts as a head support and is formed from compressible materials, such as foam, to cushion a head of an occupant (e.g., the head 154 of the driver 102 or a head of anyone else in the vehicle 104). The central region 216 has a thickness, measured in the lateral direction 214 that is greater than a set of side portions 218 of the adjustable headrest 106 extending in the horizontal direction 212 outside of the central region 216. A set of grills 220 (collectively referred to as “the grills 220”) is integrated in a front surface 222 of the adjustable headrest 106. Each of the grills 220 include an acoustically permeable structure that physically protects an associated speaker system (e.g., the one or more transducers 152) while allowing acoustic waves to pass through the grill 220. It is understood that the set of grills 220 is removably coupled to the front surface 222 of the adjustable headrest 106, as is shown in FIG. 2B. More specifically, FIG. 2B illustrates the adjustable headrest 106 with the one or more transducers 152 disposed therein, exposed.

Referring back to FIG. 2A, the front surface 222 may be positioned at different depths (e.g., positions in the lateral direction 214) at different regions of the adjustable headrest 106. For example, the front surface 222 in the region of the side portions 218 may be recessed relative to the front surface 222 in the central region 216. The set of grills 220 may be disposed in each of the side portions 218. For example, each grill 220 may be integrated in the front surface 222 of the adjustable headrest 106 (e.g., in the region of the side portions 218). In this way, a portion of the front surface 222 of the adjustable headrest 106 (e.g., in the region of the side portions 218) may be formed by the grills 220. Each grill 220 may have a length, indicated by an arrow 224, which may be shorter than the side 204 of the adjustable headrest 106. An aspect ratio of the grill 220 may have an effect on a performance of the one or more transducers 152 and the grill 220 (e.g., sound directivity, propagation, etc.). In one or more examples, an aspect ratio (e.g., length to width) of the grill 220 may be 4:1. Each grill 220 may be mirror symmetric about a central axis 226 extending approximately vertically along a height of the front surface 222. Each grill 220 may have a maximum width, indicated by an arrow 228, which is shorter than a width, indicated by an arrow 230 of the side portion 218. A front surface of the grills 220 (the surface visible in FIG. 1) may follow a curvature of an associated region of the front surface 222.

The adjustable headrest 106 also includes a plug 232 mated to a set of cables 234 for communication with the speaker system, and/or a device operated by the driver 102 (e.g., anyone else in the vehicle 104) that is executable (e.g., capable of receiving one or more inputs and generating one or more outputs) to control the sound frequency, volume, etc. The adjustable headrest 106 additionally includes a pair of rods 236 (collectively referred to as “the rods 236”) that are coupled to an inner framework of the adjustable headrest 106 and extend out of the bottom end 206 of the adjustable headrest 106 approximately along the vertical direction 210. The rods 236 may be configured to slide into a set of ports 238 (collectively referred to as “the ports 238”) in the backrest 108 of the driver seat 110 to attach the adjustable headrest 106 therein. The plug 232 is configured to communicatively attach (e.g., via a wired means) to the backrest 108 as well. Furthermore, the driver seat 110 is communicatively attached (e.g., via a wired means) to the controller 114, as is shown in FIG. 1, for example.

The adjustable headrest 106 further includes a plurality of electrically motorized actuators 240a-240c controlled by the controller 114 and at least one sensor 242. It is understood that the plurality of actuators 240a-240c may be electrically controlled (e.g., via a voltage). It is also understood that the controller 114 may adjust content output by the one or more transducers 152.

A first actuator 240a of the plurality of actuators 240a-240c is configured to cause an adjustment to the adjustable headrest 106 in a vertical direction, for example. Each of a second actuator 240b and a third actuator 240c of the plurality of actuators 240a-240c is configured to cause an angular adjustment to the set of sides 204 and/or the one or more transducers 152 disposed therein. For example, the second actuator 240b and the third actuator 240c may cause the set of sides 204 to fold toward, or away from, the central axis 226, thereby adjusting the angular positioning of the one or more transducers 152 relative to the ear(s) 146 of the driver 102. As another example, the second actuator 240b and the third actuator 240c may cause the one or more transducers 152 themselves to rotatably adjust toward, or away from, the central axis 226 without folding the set of sides 204, thereby adjusting the angular positioning of the one or more transducers 152 relative to the ear(s) 146 of the driver 102. It is understood that any combination of the angular adjustment to the set of sides 204 and/or the one or more transducers 152 and the vertical adjustment of the adjustable headrest 106 itself may be performed. It is also understood that the actuators 240a-240c may be configured to adjust different positioning and cause any type of different movements (e.g., sliding, rotating, pivoting, etc.).

It is further understood that the adjustable headrest 106 illustrated in FIGS. 2A and 2B is one or more example configurations of a headrest adapted with a speaker system. A second example of the adjustable headrest 106 may include a different number of grills disposed in the surface of the headrest. In another example, the grills may have alternate shapes or sizes. As such, it is appreciated that the scope of this disclosure should not be limited by the number, shape, or size of the grills described herein.

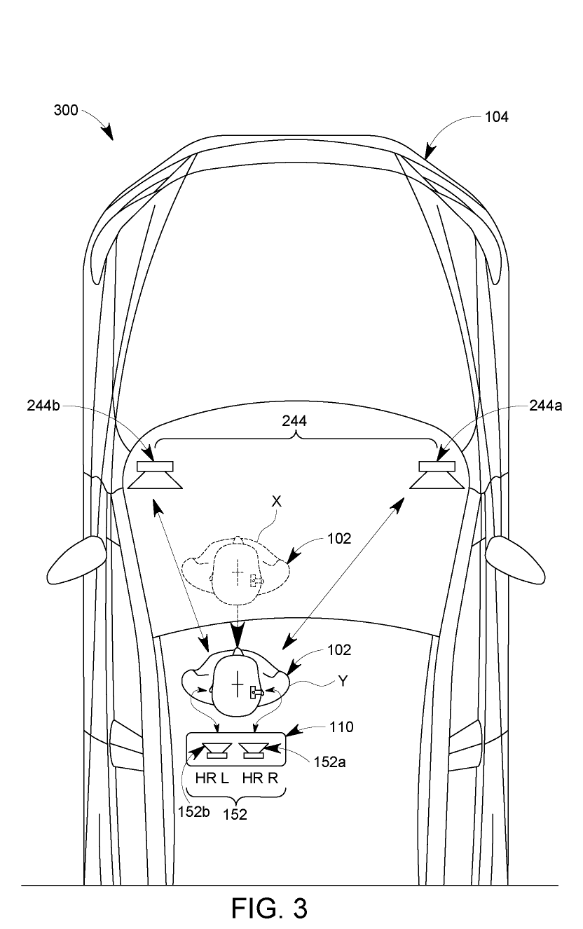

FIG. 3 generally illustrates another driving environment 300 wherein the driver 102 transitions from a first position X to a second position Y, such that the driver 102 moves rearward in the vehicle 104. For example, the driver 102 may transition from the first position X to the second position Y in an instance wherein the driver 102 repositions the driver seat 110. It should be noted that while this example illustrates the driver seat 110 moving rearward, other movements are contemplated, such as downward movement, upward movement, and tilted movement. As is depicted in FIG. 3, the first position X positions the driver 102 to be proximate to the speaker(s) 244 (closer to the speaker(s) 244 than the one or more transducers 152), while the second position Y positions the driver 102 to be proximate to the one or more transducers 152 (closer to the one or more transducers 152 than the speaker(s) 244). In other words, the first position X is disposed proximate a front of the vehicle 104, while the second position Y is disposed proximate a rear of the vehicle 104.

In one or more embodiments, as the driver 102 transitions from the first position X to the second position Y, the one or more transducers 152 can adjust content (e.g., audio) outputted by the one or more transducers 152, such as to increase a delay associated with the content, decrease a gain associated with the content, or a combination thereof. The speaker(s) 244 can additionally adjust content outputted by the speaker(s) 244 as the driver 102 transitions from the first position X to the second position Y, such as reduce a delay associated with the content, increase a gain associated with the content, or a combination thereof. It is understood that the one or more transducers 152 comprises a right transducer 152a and a left transducer 152b. It is also understood that the speaker(s) 244 comprises a right speaker 244a and a left speaker 244b. It is further understood, for example, that because the distance the driver 102 is from the right speaker 244a increases to a measurement greater than the distance the driver 102 is from the left speaker 244b as the driver 102 transitions from the first position X to the second position Y, the gain associated with the content increases more from the right speaker 244a than the left speaker 244b.

In another one or more embodiments, and in an instance wherein the driver 102 transitions from the second position Y to the first position X, the one or more transducers 152 can adjust content outputted by the one or more transducers 152, such as to decrease a delay associated with the content, increase a gain associated with the content, or a combination thereof. The speaker(s) 244 can additionally adjust content outputted by the speaker(s) 244 as the driver 102 transitions from the second position Y to the first position X, such as increase a delay associated with the content, decrease a gain associated with the content, or a combination thereof. It is understood, for example, that the gain associated with the content can change based on the position of the driver 102 in relation to the right speaker 244a and the left speaker 244b. As an example, in an instance wherein the driver 102 is disposed in a position farther from the right speaker 244a than the left speaker 244b, the gain associated with the content increases more from the right speaker 244a than the left speaker 244b. However, in another example, in an instance wherein the driver 102 is disposed in a position farther from the left speaker 244b than the right speaker 244a, the gain associated with the content increases more from the left speaker 244b than the right speaker 244a.

It is understood that in any of the example embodiments, the amount of gain associated with the content or the amount of delay change associated with the content is tunable and/or adjustable by any audio tuning mechanism (e.g., an audio tuning engineer or the driver 102). As an example, the amount of gain associated with the content or the amount of delay change associated with the content can be tunable based on a mathematical-based calculation (e.g., one or more equations) or a look-up table that can interpolate one or more values. For example, the look-up table can indicate that at a -50mm Y-position, the left transducer 152b has a gain of -3dB and a delay of 3ms. As another example, the look-up table can indicate that at a 0mm Y-position, the left transducer 152b has a gain of 0dB and a delay of 1ms. As yet another example, the look-up table can indicate that at a 50mm Y-position, the left transducer 152b has a gain of 6dB and a delay of 0ms. It is understood that as the Y-position changes, the gain and delay of the right transducer 152a can also vary. It should also be understood that values in the look-up table described above are merely for example and can be adjusted (and different values used), such as based on the type of the speaker 244, type of the one or more transducers 152, type of the vehicle 104, etc. That is, the output characteristics of the speaker 244 and/or the one or more transducers 152, as well as the configuration of the interior of the vehicle 104 or other characteristics may be different, such that the values in the look-up table are adjusted accordingly.

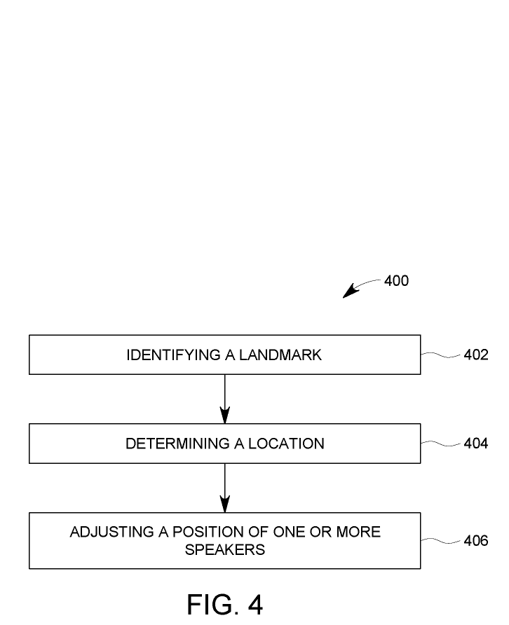

FIG. 4 is a flowchart illustrating an example method 400 for audio position adjustment relative to a headrest (e.g., the adjustable headrest 106) associated with a vehicle (e.g., the vehicle 104). At operation 402, a landmark associated with an operator (e.g., the driver 102) of the vehicle is identified. For example, the landmark is an eyebox (e.g., the eyebox 128) associated with the operator of the vehicle.

At operation 404, a location associated with the operator is determined. For example, the location is determined based on the identification of the landmark. As another example, the location is based on a physical feature of the operator. As yet another example, the physical feature includes at least one eye (e.g., the eye(s) 144) of the operator, at least one ear (e.g., the ear(s) 146) of the operator, a nose (e.g., the nose 148) of the operator, a mouth (e.g., the mouth 150) of the operator, a width of a head of the operator relative to a face of the operator, or a combination thereof. In one or more embodiments, one or more image-related signals is analyzed via a vehicle-side algorithm (e.g., the algorithm 132). For example, the analysis of the one or more image-related signals is based on the landmark.

At operation 406, a position of one or more speakers (e.g., the one or more transducers 152) is automatically adjusted. For example, the one or more speakers is disposed within the headrest of the vehicle. As another example, the position of the one or more speakers is automatically adjusted in response to the determination of the location. As yet another example, the automatic adjustment of the position of the one or more speakers changes an angular position of the one or more speakers. As a further example, the automatic adjustment of the position of the one or more speakers changes a height of the one or more speakers.

In one or more embodiments, content output by the one or more speakers is adjusted. For example, the adjustment of the content output by the one or more speakers is based on the location. As another example, the adjustment of the content by the one or more speakers changes an equalization of the content, a delay compensation of the content, a gain compensation of the content, a sound level of the content, or a combination thereof. As another example, changes in the equalization of the content may be made by an equalizer that may adjust to change sound characteristics associated with the content (e.g., bass, treble, etc.). As a further example, the content may be adjusted to change delay compensation associated with the content by delaying the content from production at the one or more speakers or another speaker (e.g., the speaker(s) 244) to reduce echoing and/or other sound-related issues. In one or more embodiments, content output by another speaker is adjusted. For example, the adjustment of the content output by the another speaker is based on the location. As another example, the adjustment of the content by the another speaker changes an equalization of the content, a delay compensation of the content, a gain compensation of the content, a sound level of the content, or a combination thereof. As yet another example, the another speaker can be one or more speakers integrated throughout the vehicle, external from the headrest.

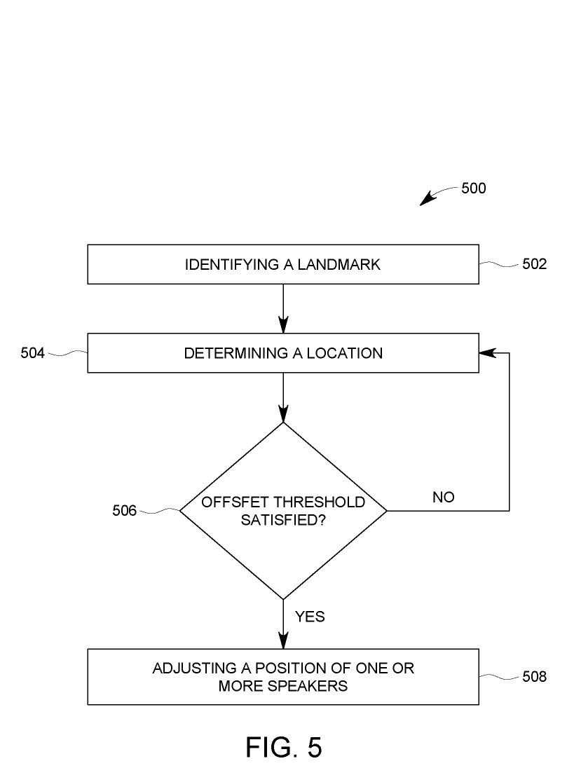

FIG. 5 is a flowchart illustrating an example method 500 for audio position adjustment relative to a headrest (e.g., the adjustable headrest 106) associated with a vehicle (e.g., the vehicle 104). At operation 502, a landmark associated with an operator (e.g., the driver 102) of the vehicle is identified. For example, the landmark is an eyebox (e.g., the eyebox 128) associated with the operator of the vehicle.

At operation 504, a location associated with the operator is determined. For example, the location is determined based on the identification of the landmark. As another example, the location is based on a physical feature of the operator. As yet another example, the physical feature includes at least one eye (e.g., the eye(s) 144) of the operator, at least one ear (e.g., the ear(s) 146) of the operator, a nose (e.g., the nose 148) of the operator, a mouth (e.g., the mouth 150) of the operator, a width of a head of the operator relative to a face of the operator, or a combination thereof.

At operation 506, a determination is made regarding whether an offset threshold is satisfied. For example, the offset threshold can be predefined corresponding to an optimal location from which the at least one ear of the operator should be located in relation to the position of one or more speakers (e.g., the one or more transducers 152) for the provision of an optimal experience for the operator. In an instance wherein the offset of the one or more speakers is determined to not satisfy the offset threshold, operation 504 is repeated and the location associated with the operator is determined again. It is understood that operation 504 can be repeated until the offset of the one or more speakers satisfies (e.g., meets or exceeds) the offset threshold. It is also understood, however, that operation 504 may only be repeated a predefined number of times before the method 500 ends.

However, in an instance wherein the offset of the one or more speakers is determined to satisfy the offset threshold, the method 500 proceeds to operation 508, wherein a position of one or more speakers is automatically adjusted. For example, the one or more speakers is disposed within the headrest of the vehicle. As another example, the position of the one or more speakers is automatically adjusted in response to the determination of the location and the satisfaction of the offset threshold. As yet another example, the automatic adjustment of the position of the one or more speakers changes an angular position of the one or more speakers. As a further example, the automatic adjustment of the position of the one or more speakers changes a height of the one or more speakers.

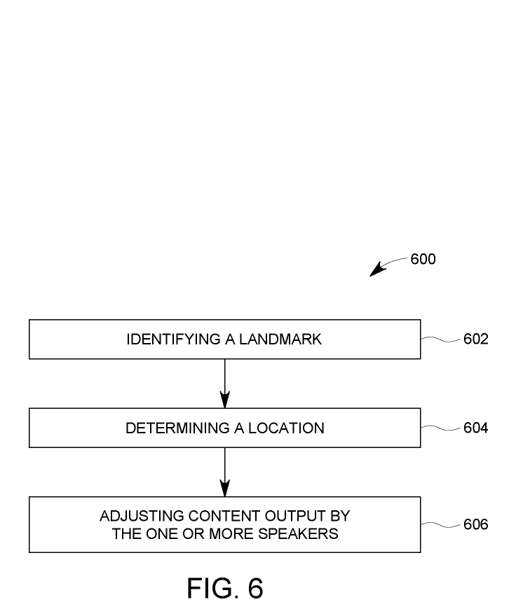

FIG. 6 is a flowchart illustrating an example method 600 for audio position adjustment relative to a headrest (e.g., the adjustable headrest 106) associated with a vehicle (e.g., the vehicle 104). At operation 602, a landmark associated with an operator (e.g., the driver 102) of the vehicle is identified. For example, the landmark is an eyebox (e.g., the eyebox 128) associated with the operator of the vehicle.

At operation 604, a location associated with the operator is determined. For example, the location is determined based on the identification of the landmark. As another example, the location is based on a physical feature of the operator. As yet another example, the physical feature includes at least one eye (e.g., the eye(s) 144) of the operator, at least one ear (e.g., the ear(s) 146) of the operator, a nose (e.g., the nose 148) of the operator, a mouth (e.g., the mouth 150) of the operator, a width of a head of the operator relative to a face of the operator, or a combination thereof.

At operation 606, content output by one or more speakers (e.g., the one or more transducers 152) is adjusted. For example, the adjustment of the content output by the one or more speakers is based on the location. As another example, the adjustment of the content by the one or more speakers changes an equalization of the content, a delay compensation of the content, a gain compensation of the content, a sound level of the content, or a combination thereof.

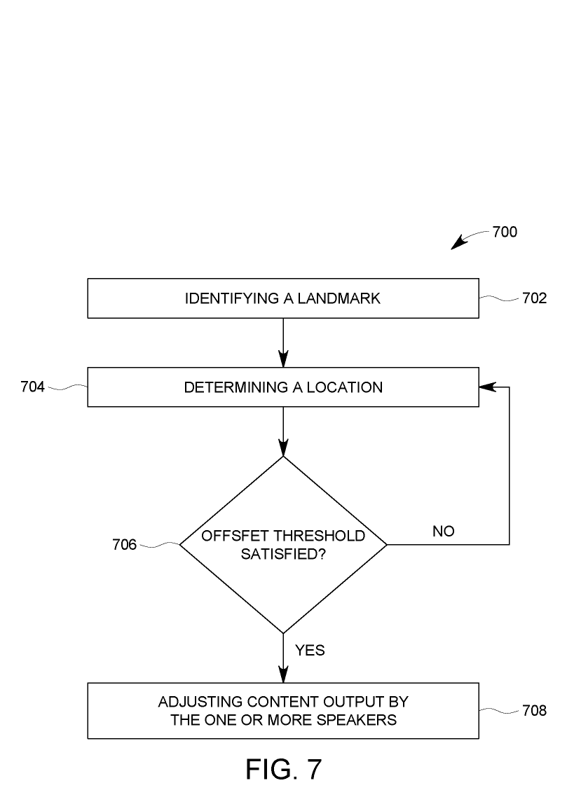

FIG. 7 is a flowchart illustrating an example method 700 for audio position adjustment relative to a headrest (e.g., the adjustable headrest 106) associated with a vehicle (e.g., the vehicle 104). At operation 702, a landmark associated with an operator (e.g., the driver 102) of the vehicle is identified. For example, the landmark is an eyebox (e.g., the eyebox 128) associated with the operator of the vehicle.

At operation 704, a location associated with the operator is determined. For example, the location is determined based on the identification of the landmark. As another example, the location is based on a physical feature of the operator. As yet another example, the physical feature includes at least one eye (e.g., the eye(s) 144) of the operator, at least one ear (e.g., the ear(s) 146) of the operator, a nose (e.g., the nose 148) of the operator, a mouth (e.g., the mouth 150) of the operator, a width of a head of the operator relative to a face of the operator, or a combination thereof.

At operation 706, a determination is made regarding whether an offset threshold is satisfied. For example, the offset threshold can be predefined corresponding to an optimal location from which the at least one ear of the operator should be located in relation to the position of the one or more speakers for the provision of an optimal experience for the operator. In an instance wherein the offset of the one or more speakers is determined to not satisfy the offset threshold, operation 704 is repeated and the location associated with the operator is determined again. It is understood that operation 704 can be repeated until the offset of the one or more speakers satisfies (e.g., meets or exceeds) the offset threshold. It is also understood, however, that operation 704 may only be repeated a predefined number of times before the method 700 ends.

However, in an instance wherein the offset of the one or more speakers is determined to satisfy the offset threshold, the method 700 proceeds to operation 708, wherein content output by one or more speakers (e.g., the one or more transducers 152) is adjusted. For example, the adjustment of the content output by the one or more speakers is based on the location. As another example, the adjustment of the content by the one or more speakers changes an equalization of the content, a delay compensation of the content, a gain compensation of the content, a sound level of the content, or a combination thereof.

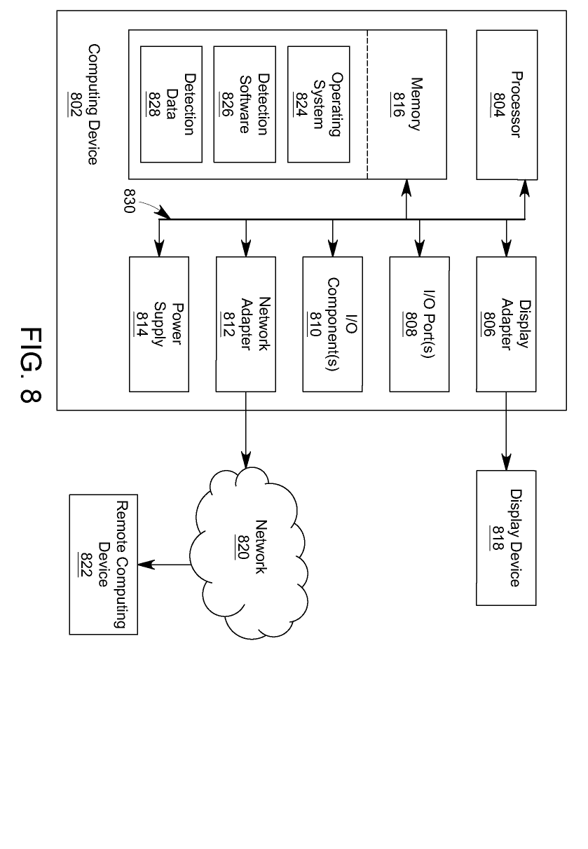

FIG. 8 illustrates an operating environment that facilitates the performance of the one or more systems and methods described herein. More specifically, the systems and methods described herein can be implemented using a computing device 802. For example, the computing device 802 can be a personal computer, a desktop, a laptop, a tablet, a hand-held computer, a server, a workstation, a mainframe, a wearable computer, a supercomputer, or a combination thereof. However, it is understood that the aforementioned examples of the computing device 802 is non-exhaustive and the computing device 802 can be any type of processing or computing device. The computing device 802 generally includes a processor 804, a display adapter 806, one or more input/output port(s) 808, one or more input/output component(s) 810, a network adapter 812, a power supply 814, and a memory 816. However, it is understood that the computing device 802 can include any additional components therein and is not required to include any of the listed components (e.g., the processor 804, the display adapter 806, the one or more input/output port(s) 808, the one or more input/output component(s) 810, the network adapter 812, the power supply 814, and the memory 816).

The processor 804 is configured to provide instructions to the computing device 802 so that the computing device 802 can process one or more tasks including the implementation of a software program to perform one or more operations as described in more detail herein. It is also understood that the computing device 802 may include any number or processors 804 therein. The display adapter 806 can be a graphics card or a video board that provides the computing device 802 with a capability to display content on a display device 818. For example, the display device 818 can be any screen, monitor, and/or light-emitting component associated with any of the personal computer, the desktop, the laptop, the tablet, the hand-held computer, the server, the workstation, the mainframe, the wearable computer, the supercomputer, or a combination thereof. However, it is understood that the aforementioned examples of the display device 818 is non-exhaustive and that the display device 818 can be any type of device capable of providing a visual display.

The input/output port(s) 808 provide a number of interfaces (e.g., sockets) for one or more cables to connect to the computing device 802. It is understood that there may be any number of input/output port(s) 808 on the computing device 802. For example, the input/output port(s) 808 provides a means for the computing device 802 to receive signals and/or data from an external device connected to the computing device 802 via the one or more cables. As another example, the input/output port(s) 808 provide a means for the computing device 802 to send signals and/or data to an external device connected to the computing device 802 via the one or more cables. The input/output component(s) 810 can include one or more components that support the input/output port(s) 808 such as, but not limited to, a switch, a push button, a pressure mat, a float switch, a keypad, a radio receive, or a combination thereof.

The network adapter 812 can be any type of network interface controller that is configured to provide a means for communicating over a network 820 with another computing device, such as a remote computing device 822. For example, the remote computing device 822 can be a user device such as a cellular-phone, a smartphone, a tablet, a laptop, or a combination thereof. The power supply 814 is configured to convert alternating high voltage current (e.g., AC) into direct current (e.g., DC) to provide regulated power to the other components (e.g., the processor 804, the display adapter 806, the one or more input/output port(s) 808, the one or more input/output component(s) 810, the network adapter 812, and the memory 816) of the computing device 802.

Additionally, the memory 816 can be a mass storage device and/or a system memory such as a hard disk drive, a memory card, a solid-state drive, random access memory (RAM), or a combination thereof. The memory 816 is configured to provide storage for instructions and data associated with the operation of the computing device 802. The memory 816 can generally include an operating system 824, detection software 826, and detection data 828. For example, the operating system 824 is configured to manage and/or process any of the data and/or instructions associated with the detection software 826 and/or detection data 828 related to the detection (e.g., identification) of the landmark associated with the operator of the vehicle, as described in more detail herein.

Furthermore, a system bus 830 is also included within the computing device 802 that is configured to couple each of the various components (e.g., the processor 804, the display adapter 806, the one or more input/output port(s) 808, the one or more input/output component(s) 810, the network adapter 812, the power supply 814, and the memory 816) of the computing device 802. It is also understood that each of the components of the computing device 802, and the functionality associated with each of the components of the computing device 802, may be implemented within the remote computing device 822. While the operating environment illustrated within FIG. 8 depicts a particular configuration associated with at least the computing device 802, the network 820, and the remote computing device 822, it is understood that the operating environment may be configured in any way.

Thus, one or more examples of the present disclosure provides a means for audio position adjustment by automatically adjusting a headrest and/or one or more transducers associated with a vehicle. Specifically, the automatic adjustment of the headrest and/or the one or more transducers provides an improved and/or optimal experience for an operator of the vehicle in a case wherein the one or more transducers are positioned within an acceptable offset threshold from at least one ear of the operator.

Based on the foregoing, the following provides a general overview of the present disclosure and is not a comprehensive summary. In a first one or more embodiments A1, a method comprising an identification of a landmark associated with an operator of a vehicle is disclosed. A determination of a location associated with the operator based on the identification of the landmark is further disclosed. Additionally, an automatic adjustment to a position of one or more speakers disposed within a headrest of the vehicle in response to the determination of the location is also disclosed.

In a second one or more embodiments A2, which may include the first one or more embodiments A1, the location is based on a physical feature of the operator. The physical feature includes at least one ear of the operator, a nose of the operator, a mouth of the operator, a width of a head of the operator relative to a face of the operator, or a combination thereof. In a third one or more embodiments A3, which may include any combination of the first through second one or more embodiments A1-A2, the determination of the location comprises analyzing, via a vehicle-side algorithm, one or more image-related signals based on the landmark, wherein the landmark is an eyebox associated with the operator of the vehicle. In a fourth one or more embodiments A4, which may include any combination of the first through third one or more embodiments A1-A3, the automatic adjustment of the position of the one or more speakers changes an angular position of the one or more speakers.

In a fifth one or more embodiments A5, which may include any combination of the first through fourth one or more embodiments A1-A4, the automatic adjustment of the position of the one or more speakers changes a height of the one or more speakers. In a sixth one or more embodiments A6, which may include any combination of the first through fifth one or more embodiments A1-A5, the method further comprising adjusting content output by the one or more speakers based on the location, wherein the adjustment of the content changes an equalization of the content, a delay compensation of the content, a gain compensation of the content, a sound level of the content, or a combination thereof. In a seventh one or more embodiments A7, which may include any combination of the first through sixth one or more embodiments A1-A6, the method further comprising adjusting content output by another speaker based on the location, wherein the adjustment of the content changes an equalization of the content, a delay compensation of the content, a gain compensation of the content, a sound level of the content, or a combination thereof.

In an eighth one or more embodiments A8, which may include any combination of the first through seventh one or more embodiments A1-A7, a system comprising one or more cameras associated with a vehicle, wherein the one or more cameras is configured to identify a landmark associated with an operator of the vehicle is disclosed. The system also comprises a controller associated with the vehicle, wherein the controller is configured to determine a location associated with the operator based on the identification of the landmark and cause an adjustment of a position of one or more speakers disposed within a headrest of the vehicle in response to the determination of the location, wherein the headrest is configured to automatically adjust the position of the one or more speakers.

In a ninth one or more embodiments A9, which may include any combination of the first through eighth one or more embodiments A1-A8, the location is based on a physical feature of the operator, and wherein the physical feature includes at least one ear of the operator, a nose of the operator, a mouth of the operator, a width of a head of the operator relative to a face of the operator, or a combination thereof. In a tenth one or more embodiments A10, which may include any combination of the first through ninth one or more embodiments A1-A9, the controller configured to determine the location is further configured to analyze, via a vehicle-side algorithm, one or more image-related signals based on the landmark, wherein the landmark is an eyebox associated with the operator of the vehicle. In an eleventh one or more embodiments A11, which may include any combination of the first through tenth one or more embodiments A1-A10, the automatic adjustment of the position of the one or more speakers changes an angular position of the one or more speakers. In a twelfth one or more embodiments A12, which may include any combination of the first through eleventh one or more embodiments A1-A11, the automatic adjustment of the position of the one or more speakers changes a height of the one or more speakers.

In a thirteenth one or more embodiments A13, which may include any combination of the first through twelfth one or more embodiments A1-A12, the controller is further configured to adjust content output by the one or more speakers based on the location, wherein the adjustment of the content changes an equalization of the content, a delay compensation of the content, a gain compensation of the content, a sound level of the content, or a combination thereof. In a fourteenth one or more embodiments A14, which may include any combination of the first through thirteenth one or more embodiments A1-A13, the controller is further configured to adjust content output by another speaker based on the location, wherein the adjustment of the content changes an equalization of the content, a delay compensation of the content, a gain compensation of the content, a sound level of the content, or a combination thereof.

In a fifteenth one or more embodiments A15, which may include any combination of the first through fourteenth one or more embodiments A1-A14, one or more non-transitory computer-readable media storing processor-executable instructions that, when executed by at least one processor, cause the at least one processor to identify a landmark associated with an operator of a vehicle, determine a location associated with the operator based on the identification of the landmark, and automatically adjust a position of one or more speakers disposed within a headrest of the vehicle in response to the determination of the location.

In a sixteenth one or more embodiments A16, which may include any combination of the first through fifteenth one or more embodiments A1-A15, the location is based on a physical feature of the operator, and wherein the physical feature includes at least one ear of the operator, a nose of the operator, a mouth of the operator, a width of a head of the operator relative to a face of the operator, or a combination thereof. In a seventeenth one or more embodiments A17, which may include any combination of the first through sixteenth one or more embodiments A1-A16, the at least one processor is further configured to analyze, via a vehicle-side algorithm, one or more image-related signals based on the landmark, wherein the landmark is an eyebox associated with the operator of the vehicle.

In an eighteenth one or more embodiments A18, which may include any combination of the first through seventeenth one or more embodiments A1-A17, the automatic adjustment of the position of the one or more speakers changes an angular position of the one or more speakers. In a nineteenth one or more embodiments A19, which may include any combination of the first through eighteenth one or more embodiments A1-A18, the automatic adjustment of the position of the one or more speakers changes a height of the one or more speakers. In a twentieth one or more embodiments A20, which may include any combination of the first through nineteenth one or more embodiments A1-19, the at least one processor is further caused to adjust content output by the one or more speakers based on the location, wherein the adjustment of the content changes an equalization of the content, a delay compensation of the content, a gain compensation of the content, a sound level of the content, or a combination thereof, or adjust content output by another speaker based on the location, wherein the adjustment of the content changes an equalization of the content, a delay compensation of the content, a gain compensation of the content, a sound level of the content, or a combination thereof.

Unless otherwise expressly indicated herein, all numerical values indicating mechanical/thermal properties, compositional percentages, dimensions and/or tolerances, or other characteristics are to be understood as modified by the word “about” or "approximately" in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method comprising:
identifying a landmark associated with an operator of a vehicle;
determining a location associated with the operator based on the identification of the landmark; and
automatically adjusting a position of one or more speakers disposed within a headrest of the vehicle in response to the determination of the location.

2. The method of claim 1, wherein the location is based on a physical feature of the operator, and wherein the physical feature includes at least one ear of the operator, a nose of the operator, a mouth of the operator, a width of a head of the operator relative to a face of the operator, or a combination thereof.

3. The method of claim 1, wherein the determination of the location comprises:
analyzing, via a vehicle-side algorithm, one or more image-related signals based on the landmark, wherein the landmark is an eyebox associated with the operator of the vehicle.

4. The method of claim 1, wherein the automatic adjustment of the position of the one or more speakers changes an angular position of the one or more speakers.

5. The method of claim 1, wherein the automatic adjustment of the position of the one or more speakers changes a height of the one or more speakers.

6. The method of claim 1, further comprising:
adjusting content output by the one or more speakers based on the location, wherein the adjustment of the content changes an equalization of the content, a delay compensation of the content, a gain compensation of the content, a sound level of the content, or a combination thereof.

7. The method of claim 1, further comprising:
adjusting content output by another speaker based on the location, wherein the adjustment of the content changes an equalization of the content, a delay compensation of the content, a gain compensation of the content, a sound level of the content, or a combination thereof.

8. A system comprising:
one or more cameras associated with a vehicle, wherein the one or more cameras is configured to identify a landmark associated with an operator of the vehicle; and
a controller associated with the vehicle, wherein the controller is configured to:
determine a location associated with the operator based on the identification of the landmark, and
cause an adjustment of a position of one or more speakers disposed within a headrest of the vehicle in response to the determination of the location, wherein the headrest is configured to automatically adjust the position of the one or more speakers.

9. The system of claim 8, wherein the location is based on a physical feature of the operator, and wherein the physical feature includes at least one ear of the operator, a nose of the operator, a mouth of the operator, a width of a head of the operator relative to a face of the operator, or a combination thereof.

10. The system of claim 8, wherein the controller configured to determine the location is further configured to:
analyze, via a vehicle-side algorithm, one or more image-related signals based on the landmark, wherein the landmark is an eyebox associated with the operator of the vehicle.

11. The system of claim 8, wherein the automatic adjustment of the position of the one or more speakers changes an angular position of the one or more speakers.

12. The system of claim 8, wherein the automatic adjustment of the position of the one or more speakers changes a height of the one or more speakers.

13. The system of claim 8, wherein the controller is further configured to:
adjust content output by the one or more speakers based on the location, wherein the adjustment of the content changes an equalization of the content, a delay compensation of the content, a gain compensation of the content, a sound level of the content, or a combination thereof.

14. The system of claim 8, wherein the controller is further configured to:
adjust content output by another speaker based on the location, wherein the adjustment of the content changes an equalization of the content, a delay compensation of the content, a gain compensation of the content, a sound level of the content, or a combination thereof.

15. One or more non-transitory computer-readable media storing processor-executable instructions that, when executed by at least one processor, cause the at least one processor to:
identify a landmark associated with an operator of a vehicle;
determine a location associated with the operator based on the identification of the landmark; and
automatically adjust a position of one or more speakers disposed within a headrest of the vehicle in response to the determination of the location.

16. The one or more non-transitory computer-readable media of claim 15, wherein the location is based on a physical feature of the operator, and wherein the physical feature includes at least one ear of the operator, a nose of the operator, a mouth of the operator, a width of a head of the operator relative to a face of the operator, or a combination thereof.

17. The one or more non-transitory computer-readable media of claim 15, wherein the at least one processor is further caused to:
analyze, via a vehicle-side algorithm, one or more image-related signals based on the landmark, wherein the landmark is an eyebox associated with the operator of the vehicle.

18. The one or more non-transitory computer-readable media of claim 15, wherein the automatic adjustment of the position of the one or more speakers changes an angular position of the one or more speakers.

19. The one or more non-transitory computer-readable media of claim 15, wherein the automatic adjustment of the position of the one or more speakers changes a height of the one or more speakers.

20. The one or more non-transitory computer-readable media of claim 15, wherein the at least one processor is further caused to:
adjust content output by the one or more speakers based on the location, wherein the adjustment of the content changes an equalization of the content, a delay compensation of the content, a gain compensation of the content, a sound level of the content, or a combination thereof; or
adjust content output by another speaker based on the location, wherein the adjustment of the content changes an equalization of the content, a delay compensation of the content, a gain compensation of the content, a sound level of the content, or a combination thereof.
